(19) United States
(12) Patent Application Publication
(10) Pub. No.: US 2019/0306468 A1
(43) Pub. Date: Oct. 3, 2019

(54) WIRELESS MONITORING SYSTEM AND POWER SAVING METHOD OF WIRELESS MONITOR

(71) Applicant: Mars Semiconductor Corp., Hsinchu (TW)

(72) Inventors: Tsung-Ming HO, Hsinchu (TW); Yi-Shing CHANG, Hsinchu (TW)

(73) Assignee: Mars Semiconductor Corp., Hsinchu (TW)

(21) Appl. No.: 15/942,612

(22) Filed: Apr. 2, 2018

(51) Int. Cl. H04N 7/18; G06T 7/215; G06K 9/00

(52) U.S. Cl. CPC H04N 7/188; G06K 9/00536; G06T 7/215; H04N 7/185

(57) ABSTRACT

A wireless monitoring system includes a wireless monitor using a battery as a power source, a transceiver for receiving an image photographed by the wireless monitor from a remote end, and an image identification unit installed in a cloud server. After a sensor of the wireless monitor is triggered, the photography module starts shooting, and the transceiver transmits the image to the cloud server for identification. If the photographed image is not a target to be monitored, the transceiver will drive the photography module of the wireless monitor to stop shooting, so as to extend the power endurance of the wireless monitor effectively.

### FIELD OF INVENTION

The present invention relates to a wireless monitoring system and a power saving method of a wireless monitor, and more particularly to the wireless monitoring system comprising a wireless monitor using a battery as the power source, a wireless transceiver, and an image identification technology installed in a cloud server, and the invention has the effects of saving power for a long-time operation of the wireless monitor and extend the power endurance.

### BACKGROUND OF INVENTION

### 1. Description of the Related Art

In a traditional monitoring or surveillance system, one or more monitors are installed to convenient positions in order to connect the mains power, and a signal transmission cable is connected to a receiver situated at a remote base station, and after the receiver receives the image captured by the monitor, the image may be displayed on a screen or recorded for surveillance.

The aforementioned cable monitoring or surveillance system has already solved the problems with regard to the power supply for the monitors and the transmission of signals, and thus the system can carry out a long-time surveillance at a fixed position. However, once the monitor is installed and fixed, it is very difficult to change its position due to the limitation of power cables and signal transmission cables. Obviously, the mobility of the traditional system is not low.

Other than the aforementioned cable surveillance system, a wireless monitoring system comprises a wireless monitor that uses one or more batteries as the power source to transmit radio signals, and a transceiver capable of receiving the image captured by the wireless monitor by at least one of the remote base stations. Since the wireless monitor is not limited by the power cables or signal transmission cables anymore, therefore the wireless monitor can be installed simply and flexibly at any required monitoring position, so that a monitoring person can monitor a place from a remote base station conveniently and safely.

For example, when a researcher studies wild animals, the researcher can observe a wild animal from a distance safely without distributing the animal by using a wireless monitor installed at a place or a path where the wild animal may pass. When the wild animal enters into the photographing range of the wireless monitor, the wireless monitor will transmit the captured image to a transceiver (such as a notebook computer, a tablet PC, a mobile phone, or a display device having a wireless signal transmission module) of a remote base station for the researcher's observation and study.

In another example, a wireless monitor may be installed at an important place having a temporary need for monitoring and surveillance, and if a person enters into such importance place, the wireless monitor will transmit a photographed image to the transceiver of the remote base station. Such arrangement not just can achieve the effect of monitoring the place only, but also has the advantage of convenient installation.

Although the aforementioned wireless monitoring system has the advantages of high mobility and convenient use, yet the power source of the wireless monitor of the traditional wireless monitoring system just relies on battery for the power. Once the battery power is exhausted, the whole wireless monitoring system is disabled. Therefore, the system design of the wireless monitor requires a power-saving mechanism to extend the power endurance.

In related prior arts, U.S. Pat. Nos. 7,928,842, 8,193,933, and 7,609,952 have disclosed a power saving method of a wireless monitor in a remote surveillance system, these patents basically keep the wireless monitor in a sleep mode to save power, and then use a timer, a remote control or a sensor to wake the wireless monitor in the sleep mode, so that the wireless monitor can be set into the sleep mode again after a period of time, ad the power saving effect is achieved.

In the U.S. Pat. Nos. 7,928,842, 8,193,933, and 7,609,952, a timer is used, or a manual remote control is used to wake up the wireless monitor, and thus the wireless monitor in the sleep mode sometimes may miss a target required to be monitored. By comparison, the way of using a sensor to wake the wireless monitor in the sleep mode is more reliable. In addition, a general sensor such as a PIR motion sensor is a low-power component that consumes very little power and has the advantage for a long-time monitoring task.

However, a general sensor just can detect whether or not a moving object has entered into the photographing range of the wireless monitor. When the sensor is triggered, the wireless monitor starts shooting, and the photographed image is highly probably not a target required to be monitored. For example, if a pet such as a cat or a dog passes through an area (that required to be monitored) or even stays in the sensing range of the PIR motion sensor for a long time, the wireless monitor will keep shooting the unnecessary screens, and thus wasting a lot of time and workload to check the captured images and a large amount of power consumed by the wireless monitor.

Therefore, the inventor of the present invention conceived an idea of using other technologies to assist the sensor to identify a moving object required to be monitored correctly, and stop shooting once the photographed moving object is found to be not a target to be monitored, so as to prevent the wireless monitor from shooting unnecessary images for a long time and save the power of the wireless monitor.

The image identification software is a well-developed technology, and its principle is basically to capture a light change characteristic of an object to be identified or a moving object such as a human face, a human body, or an animal from the background screen and then convert the light change characteristic into data in order to calculate and identify whether or not a subsequent captured image matches with the moving object such as a human face, a human body or an animal having the light change characteristic.

Theoretically, an image identification technology added to the wireless monitoring system may help the sensor to identify the moving object required to be monitored correctly. However, the comparison performed by the image identification software takes a lot of computing time during the identification process, so that hardware devices must have a very high computing power, or else the image identification process takes too much time for the computation. This is undoubtedly an obstacle to the instant identification function of the wireless monitor.

### 2. Summary of the Invention

Therefore, it is a primary objective of the present invention to overcome the drawbacks of the prior art by providing a wireless monitoring system and a power saving method of a wireless monitor, and the system can solve the problem of the prior art failing to correctly identify whether or not the photographed image is a target required to be monitored after the wireless monitor is turned on, and the wireless monitor can be operated in a long time without wasting power unnecessarily and the power endurance of the wireless monitor can be extended.

To achieve the aforementioned and other objectives, the present invention discloses a wireless monitoring system, comprising: a wireless monitor using a battery as a power source, a transceiver for receiving an image photographed by the wireless monitor from a remote end, and an image identification unit installed in a cloud server, characterized in that the wireless monitor comprises a sensor maintained at an ON state, a microprocessor maintained in a sniffing mode, a photography module and a first wireless transmission module maintained at an OFF state, and a power circuit electrically coupled to a battery for supplying power for the operation of each component; after the sensor is triggered by a moving object in a sensing range, the photography module and the first wireless transmission module are turned on by the microprocessor and the power circuit, so that the photography module starts shooting an image, and the photographed image is outputted through the first wireless transmission module; the transceiver is always maintained at an ON state and comprises a second wireless transmission module, a controller, and a network transmission interface, wherein the second wireless transmission module is provided for receiving an image outputted by the first wireless transmission module and transmitting the image to the cloud server by connecting the controller and network transmission interface to the Internet, and an image identification unit of the cloud server identifies the image photographed by the wireless monitor; and if the image identification unit identifies the image and determines that the image photographed by the wireless monitor is not a target to be monitored, then the second wireless transmission module and the controller of the transceiver will return a signal to the wireless monitor, and the microprocessor of the wireless monitor will stop the operation photography module and the first wireless transmission module.

In the aforementioned system, the sensor and microprocessor of the wireless monitor maintained at the ON/sniffing mode consume very little power, so that the wireless monitor can perform the monitoring task for a long time effectively. After the sensor is triggered to turn on the photography module and the first wireless transmission module (which consume much power), the photographed image can be uploaded to the image identification unit of the cloud server through the transceiver for identification. If the image is identified to be not a target to be monitored, the operation of the photography module and the first wireless transmission module of the wireless monitor will be stopped, so as to achieve effect of saving the power and extending the power endurance of the wireless monitor.

Wherein, the sensor of the wireless monitor is a PIR motion sensor.

Wherein, the photography module of the wireless monitor comprises a camera lens, an image sensor and a main control chip, and the main control chip is provided for processing the image captured by the camera lens and the image sensor and then transmitting the processed image to the second wireless transmission module of the transceiver through the first wireless transmission module; and the controller of the transceiver is a secondary control chip for processing the image received by the second wireless transmission module and transmitting the processed image to the network transmission interface.

Wherein, the network transmission interface of the transceiver is a wireless network transmission module, or a network transmission port capable of connecting to an external router through a network transmission cable.

Wherein, the transceiver further comprises a storage medium electrically coupled to the controller for storing an image received by the second wireless transmission module.

Wherein, the storage medium includes but not limited to a hard disk, a flash memory, a removable memory card, or a flash drive.

Wherein, the target to be monitored includes but not limited to a human face or a human body.

The present invention also provides a power saving method of a wireless monitor, and comprises a power circuit using a battery as a power source, a sensor, a microprocessor, a photography module, and a first wireless transmission module, and the power saving method comprises the steps of:

(a) maintaining the sensor in a standby mode at an ON state, the microprocessor in a sniffing mode, and the photography module and the first wireless transmission module at an OFF state;

(b) triggering the sensor when a moving object enters into a sensing range of the sensor, transmitting a signal to the microprocessor by the sensor, and turning on the photography module and the first wireless transmission module by the microprocessor;

(c) starting shooting after the photography module is turned on, and outputting the photographed image to a second wireless transmission module of an external transceiver through the first wireless transmission module;

(d) transmitting the image of the moving object received by the external transceiver to a cloud server, and identifying the image by an image identification unit of the cloud server to determined whether the image is a target to be monitored;

(e) continuing to shoot by the wireless monitor until the moving object 1 leaves the sensing range of the sensor, if the image identification unit identifies and determines that the image of the moving object is a target to be monitored, turning off the photography module and the first wireless transmission module by the microprocessor, and returning to Step (a); and

(f) returning a signal to turn off the photography module and the first wireless transmission module by the microprocessor, if the image identification unit of the cloud server identifies and determines that the image of the moving object is not a target to be monitored, returning to Step (a) and carrying out Step (b) when the next moving object enters into the sensing range of the sensor to trigger the sensor.

Wherein, the image is sent and stored into a storage medium when the external transceiver transmits the image to the cloud server in Step (d).

Wherein, the target to be monitored includes but not limited to a human face or a human body.

Compared with the prior art, the wireless monitoring system and the power saving method of the present invention can perform a monitoring task for a long time by maintaining the sensor and the microprocessor (which consume very little power) of the wireless monitor at the ON/sniffing mode. After the sensor is triggered to turn on the photography module and the first wireless transmission module (which consume much more power), the photographed image is uploaded to the image identification unit of the cloud server through the transceiver for identification immediately. If the image is identified to be not a target to be monitored, the operation of the photography module and second wireless transmission module of the wireless monitor will be stopped. The invention not just overcome the problem of the traditional wireless monitor failing to make the identification correctly only, but also achieves the effect of saving the power and extending the power endurance of the wireless monitor.

The above and other objects, features and advantages of this invention will become apparent from the following detailed description taken with the accompanying drawings.

### BRIEF DESCRIPTION OF THE DRAWINGS

FIG. 1 is a schematic block diagram showing the components of a wireless monitoring system of the present invention.

### DESCRIPTION OF THE PREFERRED EMBODIMENTS

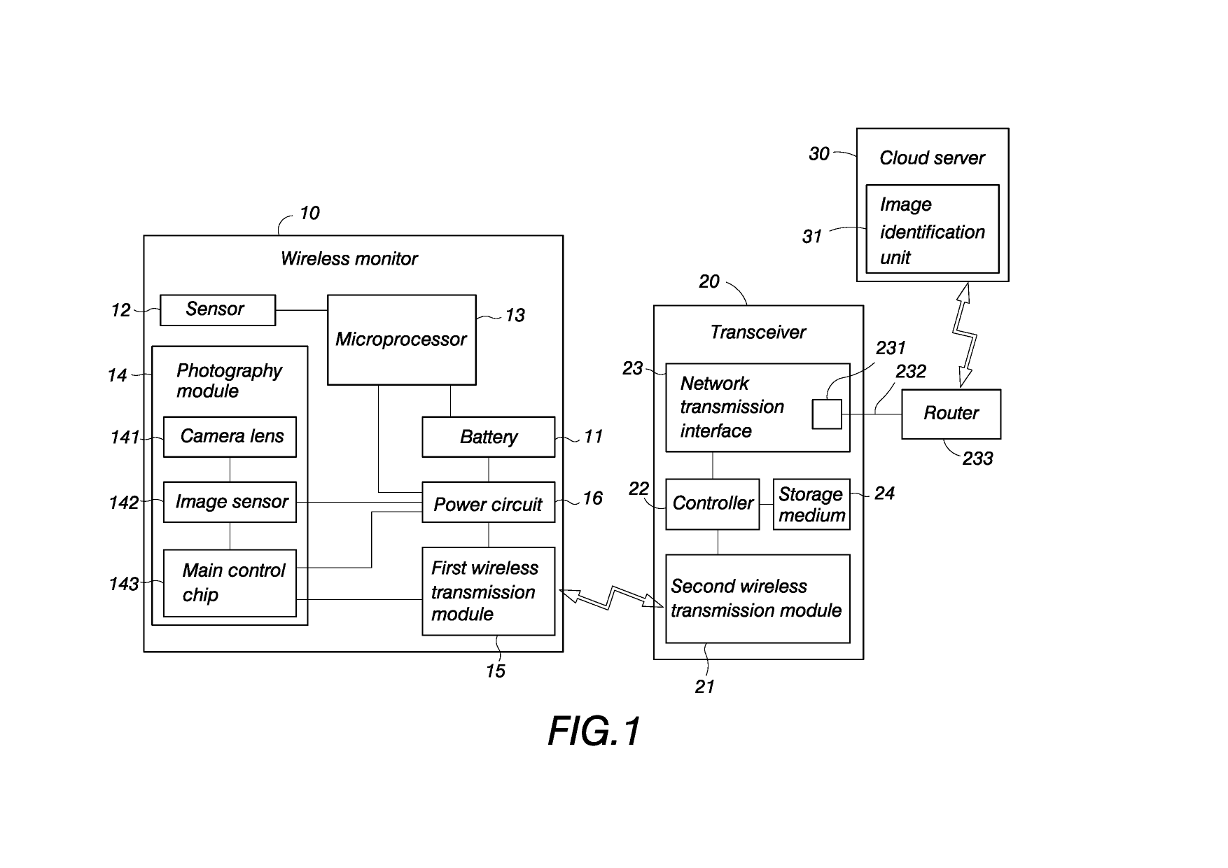

With reference to FIG. 1 for a wireless monitoring system of the present invention, the wireless monitoring system comprises a wireless monitor 10, a transceiver 20 for receiving an image captured by the wireless monitor 10 from a remote end, and an image identification unit 31 installed in a cloud server 30.

The wireless monitor 10 uses a battery 11 as the power source and comprises a sensor 12, a microprocessor 13, a photography module 14, a first wireless transmission module 15, and a power circuit 16 electrically coupled to the battery 11 for supplying the power required for the operation of different components.

In an embodiment, the sensor 12 is a PIR motion sensor, and the photography module 14 comprises a camera lens 141, an image sensor 142, and a main control chip 143, and the main control chip 143 is provided for processing the image captured by the camera lens 141 and the image sensor 142 and transmitting the processed image to the first wireless transmission module 15, and the first wireless transmission module 15 transmits the image to the transceiver 20. The camera lens 141, image sensor 142 and main control chip 143 are prior arts of the general photography technology and thus will not be described here.

The transceiver 20 is installed at a remote base station and always maintained at an ON state. The transceiver 20 comprises a second wireless transmission module 21 for receiving an image outputted by the first wireless transmission module 15, a controller 22, and a network transmission interface 23. In an embodiment, the controller 22 is a secondary control chip for processing an image received by the second wireless transmission module 21 and transmitting the processed image to the network transmission interface 23, and then from the network transmission interface 23 to the cloud server 30. In addition, the network transmission interface 23 may be a wireless network transmission module, such as WiFi, 4G, 5G, or coupled to a network transmission port 231 of an external router 233 through a network transmission cable 232.

In FIG. 1, the transceiver 20 further comprises a storage medium 24 electrically coupled to the controller 22 for storing the image received by the second wireless transmission module 21. The storage medium 24 includes but not limited to a hard disk, a flash memory, a removable memory card, or a flash drive, etc.

In an embodiment, the image identification unit 31 of the cloud server 30 is an image identification software program capable of capturing a light change characteristic of a moving object or a target to be identified such as a human face, a human body, or an animal from a background screen and converted into data in order to calculate whether or not the subsequent photographed image has matches a human face, a human body or an animal that matches the light change characteristic. This image identification software is a well-developed technology, and thus will not be described here.

In the aforementioned system, the power saving method of the present invention wireless monitor comprises the following steps:

Step (a): The wireless monitor 10 is situated at a standby mode, the PIR motion sensor 12 is maintained at an ON state, the microprocessor 13 is maintained at a sniffing mode, and the photography module 14 and first wireless transmission module 15 are maintained at an OFF state. Since the sensor 12 in the ON state and the microprocessor 13 in the sniffing mode consume very little power, and the photography module 14 and first wireless transmission module 15 consuming much more power are maintained at the OFF state, therefore the battery 11 can supply power to the sensor 12 and the microprocessor 13 through the power circuit 16 for a long time.

Step (b): When a moving object enters into the sensing range of the sensor 12 to trigger the sensor 12, the sensor 12 transmits a signal to the microprocessor 13 in the sniffing mode. After the microprocessor 13 receives the signal, the photography module 14 and the first wireless transmission module 15 are turned on by the power circuit.

Step (c): After the photography module 14 is turned on, the camera lens 141 starts shooting, and the captured outside light is transmitted to the image sensor 142. After the image sensor 142 converts the light into image data, the image data are sent to the main control chip 143, and the main control chip 143 processes the image and transmit the processed image to the first wireless transmission module 15, and then the first wireless transmission module 15 transmits the image to the transceiver 20, and the image is received by the second wireless transmission module 21 of the transceiver 20.

Step (d): After the second wireless transmission module 21 of the transceiver 20 receives the image of the moving object transmitted from the wireless monitor 10, the image is processed by the controller 22 and transmitted to the network transmission interface 23, and then transmitted from the network transmission interface 23 connected to the Internet to the cloud server 30, and the image identification unit 31 of the cloud server 30 identifies whether or not the image is a target to be monitored. In this embodiment, the controller 22 transmits the processed image to the network transmission interface 23 and also transmits the processed image to the storage medium 24 for storage at the same time, so as to facilitate reviewing the image at a later time.

Step (e): When the image identification unit 31 of the cloud server 30 identifies that the image of the moving object is a target to be monitored (for example, the image matches with the profile characteristic of a human face or a human body), no response is required, and the photography module 14 and the first wireless transmission module 15 of the wireless monitor 10 can continue shooting and transmitting until the moving object leaves the sensing range of the sensor 12. Now, the sensor 12 stops transmitting signals to the microprocessor 13, and the microprocessor 13 stops the power circuit 16 to supply power to the photography module 14 and the first wireless transmission module 15, so that the photography module 14 and the first wireless transmission module 15 resumes their OFF state as in Step (a). Until the next moving object enters into the sensing range of the sensor 12 to trigger the sensor 12, the Step (b) is carried out.

Step (f): When the image identification unit 31 of the cloud server 30 identifies the image of the moving object and determines that the image is not a target to be monitored (such as a cat, a dog, or a small animal failing to match with the profile characteristic of a human face or a human body), the Internet returns a signal to the transceiver 20, and the signal is transmitted to the wireless monitor 10 through the controller 22 and the second wireless transmission module 21 of the transceiver 20, and the microprocessor 13 of the wireless monitor 10 turns off the photography module 14 and the first wireless transmission module 15, so that the wireless monitor 10 resumes its status as described in the Step (a). In other words, the sensor 12 is maintained at the ON state, the microprocessor 13 is maintained in the sniffing mode, and the photography module 14 and first wireless transmission module 15 are maintained at the OFF state. Until the next moving object enters into the sensing range of the sensor 12, the Step (b) is carried out. As described above, although the sensor 12 and the microprocessor 13 are still in an operating status after the photography module 14 and the first wireless transmission module 15 are turned off, the power consumption is very small, so that power can be supplied by the battery 11 for a long time, and the power endurance of the wireless monitor 10 can be extended effectively.

While the invention has been described by means of specific embodiments, numerous modifications and variations could be made thereto by those skilled in the art without departing from the scope and spirit of the invention set forth in the claims.

What is claimed is:

1. A wireless monitoring system, comprising: a wireless monitor using a battery as a power source, a transceiver for receiving an image photographed by the wireless monitor from a remote end, and an image identification unit installed in a cloud server, characterized in that the wireless monitor comprises a sensor maintained at an ON state, a microprocessor maintained in a sniffing mode, a photography module and a first wireless transmission module maintained at an OFF state, and a power circuit electrically coupled to a battery for supplying power for the operation of each component; after the sensor is triggered by a moving object in a sensing range, the photography module and the first wireless transmission module are turned on by the microprocessor and the power circuit, so that the photography module starts shooting an image, and the photographed image is outputted through the first wireless transmission module; the transceiver is always maintained at an ON state and comprises a second wireless transmission module, a controller, and a network transmission interface, wherein the second wireless transmission module is provided for receiving an image outputted by the first wireless transmission module and transmitting the image to the cloud server by connecting the controller and network transmission interface to the Internet, and an image identification unit of the cloud server identifies the image photographed by the wireless monitor; and
if the image identification unit identifies the image and determines that the image photographed by the wireless monitor is not a target to be monitored, then the second wireless transmission module and the controller of the transceiver will return a signal to the wireless monitor, and the microprocessor of the wireless monitor will stop the operation photography module and the first wireless transmission module.

2. The wireless monitoring system of claim 1, wherein the sensor of the wireless monitor is a PIR motion sensor.

3. The wireless monitoring system of claim 1, wherein the photography module of the wireless monitor comprises a camera lens, an image sensor and a main control chip, and the main control chip is provided for processing the image captured by the camera lens and the image sensor and then transmitting the processed image to the second wireless transmission module of the transceiver through the first wireless transmission module; and the controller of the transceiver is a secondary control chip for processing the image received by the second wireless transmission module and transmitting the processed image to the network transmission interface.

4. The wireless monitoring system of claim 1, wherein the network transmission interface of the transceiver is a wireless network transmission module, or a network transmission port capable of connecting to an external router through a network transmission cable.

5. The wireless monitoring system of claim 1, wherein the transceiver further comprises a storage medium electrically coupled to the controller for storing an image received by the second wireless transmission module.

6. The wireless monitoring system of claim 1, wherein the storage medium includes but not limited to a hard disk, a flash memory, a removable memory card, or a flash drive.

7. The wireless monitoring system of claim 1, wherein the target to be monitored includes but not limited to a human face or a human body.

8. A power saving method of a wireless monitor, and the wireless monitor comprising a power circuit using a battery as a power source, a sensor, a microprocessor, a photography module, and a first wireless transmission module, and the power saving method comprising the steps of:
(a) maintaining the sensor in a standby mode at an ON state, the microprocessor in a sniffing mode, and the photography module and the first wireless transmission module at an OFF state;
(b) triggering the sensor when a moving object enters into a sensing range of the sensor, transmitting a signal to the microprocessor by the sensor, and turning on the photography module and the first wireless transmission module by the microprocessor;
(c) starting shooting after the photography module is turned on, and outputting the photographed image to a second wireless transmission module of an external transceiver through the first wireless transmission module;
(d) transmitting the image of the moving object received by the external transceiver to a cloud server, and identifying the image by an image identification unit of the cloud server to determined whether the image is a target to be monitored;
(e) continuing to shoot by the wireless monitor until the moving object 1 leaves the sensing range of the sensor, if the image identification unit identifies and determines that the image of the moving object is a target to be monitored, turning off the photography module and the first wireless transmission module by the microprocessor, and returning to Step (a); and
(f) returning a signal to turn off the photography module and the first wireless transmission module by the microprocessor, if the image identification unit of the cloud server identifies and determines that the image of the moving object is not a target to be monitored, returning to Step (a) and carrying out Step (b) when the next moving object enters into the sensing range of the sensor to trigger the sensor.

9. The power saving method of a wireless monitor according to claim 8, wherein the image is sent and stored into a storage medium when the external transceiver transmits the image to the cloud server in Step (d).

10. The power saving method of a wireless monitor according to claim 8, wherein the target to be monitored includes but not limited to a human face or a human body.
